(19) United States
(12) Patent Application Publication
(10) Pub. No.: US 2003/0125815 A1
(43) Pub. Date: Jul. 3, 2003

(54) E-installation system and method for use in installation of power-plant equipment

(76) Inventors: George Hanna Ghanime, Ballston Spa, NY (US); Jane M. Cooper, Atlanta, GA (US); Gary Mlakar, Atlanta, GA (US); Thomas Arthur Wagner, Troy, NY (US); Rui Zhou, Clifton Park, NY (US)

Correspondence Address: NIXON & VANDERHYE P.C., 8th Floor, 1100 North Glebe Road, Arlington, VA, 22201, US

(21) Appl. No.: 10/138,486

(22) Filed: May 6, 2002

Related U.S. Application Data
(63) Continuation-in-part of application No. 10/032,137, filed on Dec. 31, 2001, now abandoned.

(51) Int. Cl. G06F 9/445; G06F 17/00; G06F 7/00; G05B 15/00

(52) U.S. Cl. 700/1; 717/174

(57) ABSTRACT

In a communications network having at least one server, a plurality of distributed databases communicatively linked to the server, and the distributed databases having installation documents related to power plant equipment stored therein, a plurality of users communicatively linked to the server, a method for providing access to installation documents for assisting at least one user in installing power-plant equipment includes providing at the server an installation software tool for use by the user. The also includes supplying a list correlating source locations of installation documents stored in the plurality of distributed databases with installation software tool destination locations. The installation software tool is populated with links to the installation documents using information from the list, and installation documents are retrieved from the plurality of distributed databases in response to user selection of links using the installation software tool.

### RELATED APPLICATION

This application is a continuation-in-part of U.S. patent application Ser. No. 10/032,137, filed Dec. 31, 2001, which is incorporated by reference.

### FIELD OF THE INVENTION

This invention generally relates to expert and workflow systems, and more particularly, to a system for assisting a field engineer located at a remote site to intelligently retrieve installation data stored in one or more of a plurality of distributed databases and populate an application program with the retrieved data to address equipment installation milestones.

### BACKGROUND OF THE INVENTION

Most power plants typically use pre-packaged instrumentation and control subsystems supplied by the original equipment manufacturers of gas or steam turbines. Current installation practices require mobilization of technical advisors (TA's) to an installation site for installation of turbine equipment. Upon arriving at an installation site, a TA usually establishes communication with the TA's home office. The TA may subsequently issue a request to forward supporting documents and drawings required for installing given equipment. Once the request is processed, a list of supporting documents and drawings is generated to be sent, via mail or other forms of transmission, to the TA at the installation site. This process of forwarding documents and drawings to a TA can be time consuming and sometimes unreliable, and thus difficult to implement when faced with short installation schedules.

Sometimes, documents generated and shipped to remote installation sites are incomplete. In some cases, forwarded information is outdated or may not make it to the TA located in the field. Thus, there is a need to automate the process of forwarding information to a TA at a field installation site while ensuring that the forwarded information is current.

### BRIEF SUMMARY OF THE INVENTION

The present invention provides systems and methods to overcome the problems identified by earlier approaches. Illustrative embodiments enable the creation, capture, organization, storage, retrieval, manipulation and controlled circulation of documents in an electronic format. An embodiment of the present invention enables a technical advisor (TA) or field engineer, situated at a field installation site, to install a given equipment in the field. The embodiment further addresses installation milestones of power plant equipment and provides a TA or field engineer with installation procedures and requirements to complete each identified milestone.

In one illustrative non-limiting embodiment, an installation manager establishes a given e-installation site in an installation server, and adds equipment information that needs to be installed at a field site to the e-installation site. The e-installation site also stores information pertaining to the installation of equipment at the field site. The equipment-specific information is stored in one or more distributed databases. A master list is prepared to identify locations of installation documents stored in various databases within a network and the destination locations of the documents in an installation tool stored in the installation server. The installation manager uses the master list to automatically populate the installation tool with installation milestones, tasks and sub-tasks within a milestone, and information or links to information required to fulfill the various tasks and sub-tasks.

Once the pre-installation tasks are completed by the installation manager, an installation site is issued for use by a field engineer or Technical Advisor. The field engineer may access the milestone-based schedule to obtain information supporting the tasks or sub-tasks identified in the milestone-based schedule.

One embodiment offers in a communications network having at least one server, a plurality of distributed databases communicatively linked to the server, and the distributed databases having installation documents related to power plant equipment stored therein. A plurality of users are communicatively linked to the server, and a method for providing access to installation documents for assisting at least one user in installing power-plant equipment includes: providing at the server an installation software tool for use by the user; supplying a list correlating source locations of installation documents stored in the plurality of distributed databases with installation software tool destination locations; populating the installation software tool with links to the installation documents using information from the list; and retrieving installation documents from the plurality of distributed databases in response to user selection of links using the installation software tool.

The plurality of distributed databases may further include first and second databases. The method further may include storing a bill of materials in the first database and storing documents associated with the bill of materials in the second database. The documents stored in the second database refer to the bill of materials stored in the first database. The second database may also store electronic media files.

The step of populating the software tool may include using destination locations identified in the list to organize links to installation documents into a hierarchical set within the software tool, and wherein the populating step comprises providing links to at least one of (i) a html document, (ii) a drawing file, and (ii) a text document.

The method of providing access to installation documents may further include enabling the remote user to search the plurality of distributed databases for installation documents related to the power-plant equipment; and providing links to resources to support installation of the power-plant equipment. The user may be enabled to communicate over the network with other users performing installation tasks.

Another embodiment is a computer-based method for helping a user to install power plant equipment, the method includes executing on a computer, a software tool that provides the user with access to installation documents stored in any of a plurality of databases residing on plural further computers. The software tool may preferably display an installation schedule with milestone indices. This method includes allowing the user to select a milestone index; and in response to selection of a milestone index, displaying hierarchical set of tasks and subtasks associated with the selected milestone index. The set of tasks and subtasks have corresponding links to associated installation documents stored in said plurality of databases. If required, the method provides a link to an equipment data record compliance form for at least one task; enables the user to retrieve and populate the compliance form; and transmits the populated compliance form to one of the plurality of distributed databases.

Another embodiment is a system for providing access to documents for assisting at least one user in installing power-plant equipment, the system provides a plurality of databases, any of the databases storing installation documents, a server having an installation software tool for use by the user. The system further includes a communications network communicatively coupling the server and the plurality of databases for enabling the user to access and retrieve installation documents from the server. The server may include a table having a listing source locations of installation documents stored in the plurality of databases and correlating destination locations in the software tool. The plurality of databases preferably include first and second databases, wherein the first database stores a bill of materials and the second database stores documents associated with the bill of materials. The documents stored in the second database preferably refer to the bill of materials stored in the first database.

The second database further includes electronic media files. The software tool preferably includes references to installation documents, the references being organized into a hierarchical set of tasks and subtasks; and wherein the references are further organized using destination locations listed in the table. The software tool preferably includes a search feature for enabling the user to search the plurality of databases for documents related to the installation of the power-plant equipment, and a links feature for providing links to resources to support installation of the power-plant equipment. The software tool also includes a communication link for enabling the user to communicate over the network with other users performing installation tasks.

Another embodiment is a system for providing access to digitized documents for helping a user to install power-plant equipment, the system includes a plurality of distributed databases for storing the digitized documents related to power plant equipment; an e-matrix database for storing a first set of data; a server having an application software tool stored therein. The server is communicatively coupled to the plurality of databases and the e-matrix database via a communication network. The software tool when executed automatically populates the server with links to the digitized documents stored in the distributed databases; and wherein the server is supplied with a list correlating source locations of installation documents stored in the plurality of databases with installation software tool destination locations.

Another illustrative aspect provides in a computer system coupled to an electronic communications network, the computer system including a display and at least one user input device, an equipment installation wizard for assisting engineers in performing tasks relating to installation and/or maintenance of heavy machines such as power plant equipment, the equipment installation wizard including: a task scheduler that displays a predetermined sequence of plural tasks; a resource detailer that displays a list of resources associated with the selected task in response to the user input device indicating selection of the task; and a digital resource retriever operatively coupled to the resource detailer and responsive to the task selection and the user input device, the digital resource retriever allowing a user to select resources from the displayed list and automatically retrieving a digital version of the selected resources via the network, wherein the wizard includes an automatic populator that dynamically updates the list displayed by the resource detailer by importing resource descriptions and associated tasks from at least one file.

The digital resource retriever retrieves the resources based on universal resource locators. The resources may include technical drawings, installation manuals, and bill of materials of the equipment. The resources may also include streaming electronic media. The system may also include a compliance verifier that reports successful completion of the task over the network. A chat facility is provided for allowing users to communicate over the network. The wizard may be accessed over the network via a web browser. The automatic populator preferably conditions importation of resources into the wizard on the confirmed existence of the resources. The automatic populator may also preferably condition importation of resources into the wizard on confirmation of task definition by the task scheduler.

### BRIEF DESCRIPTION OF THE DRAWINGS

FIG. 1 shows a high level schematic of an e-installation system in accordance with an exemplary embodiment of the present invention.

FIG. 2 is a flow-chart illustrating various process steps performed by an installation manager during a pre-installation task of the e-installation system as in FIG. 1;

FIG. 3 is a flow-chart illustrating further process steps performed by an installation manager in setting up an e-installation tool/wizard prior to issuing a power plant unit in accordance with an exemplary embodiment of the present invention;

FIG. 4 is a flow-chart illustrating the process steps involved for populating the e-installation tool in accordance with an example embodiment of the present invention;

FIG. 5 is a user-interface of the e-installation tool showing milestone information in accordance with an example embodiment of the present invention;

FIG. 6 shows an exemplary hierarchical organization chart of the e-installation tool in accordance with an example embodiment of the present invention;

FIG. 7 is a high-level flow chart illustrating steps involved for generating a template/master-list table from information provided by a field engineer in accordance with an exemplary embodiment of the present invention.

FIG. 8 illustrates an architectural design schematic of the e-installation system for populating the e-installation tool in accordance with an example embodiment of the present invention;

FIG. 9 is an exemplary template/master-list table created from information received from a field engineer, the template identifying the source and destination locations of installation documents in accordance with an example embodiment of the present invention;

FIGS. 10 and 11 show user interface screens for enabling a user/field engineer to retrieve details of a specific installation item in accordance with an example embodiment of the present invention;

FIG. 12 shows a schematic of a COPICS cools integration system architecture of the e-installation system as shown in FIG. 1; and

FIG. 13 illustrates a computer system carried by a technical advisor (TA) or a field engineer (FE) for carrying out equipment installation tasks.

### DETAILED DESCRIPTION OF EXEMPLARY EMBODIMENTS

### Definitions

Template/masterlist table is defined to be a subset of information retrieved by an installation manager for a given power plant equipment. Template/masterlist table is designed to locate installation documents including drawings related to power plant equipment. Each of the drawings and installation documents are identified by a unique prefix. The masterlist further includes the destination location for each of the installation documents in an e-installation tool, the destination location identifying a milestone/task/sub-task hierarchical structure.

E-Matrix is defined as a database which stores business objects and work flows for populating the e-installation software tool.

COPICS which stands for Communication Oriented Production and Information Control System is a database for ordering parts for power plant equipment and documenting the orders. For example, the COPICS database may preferably be used by design teams, sourcing, finance and manufacturing departments.

DART which stands for Document Archive and Retrieval Tool is a database for power plant equipment drawing media files.

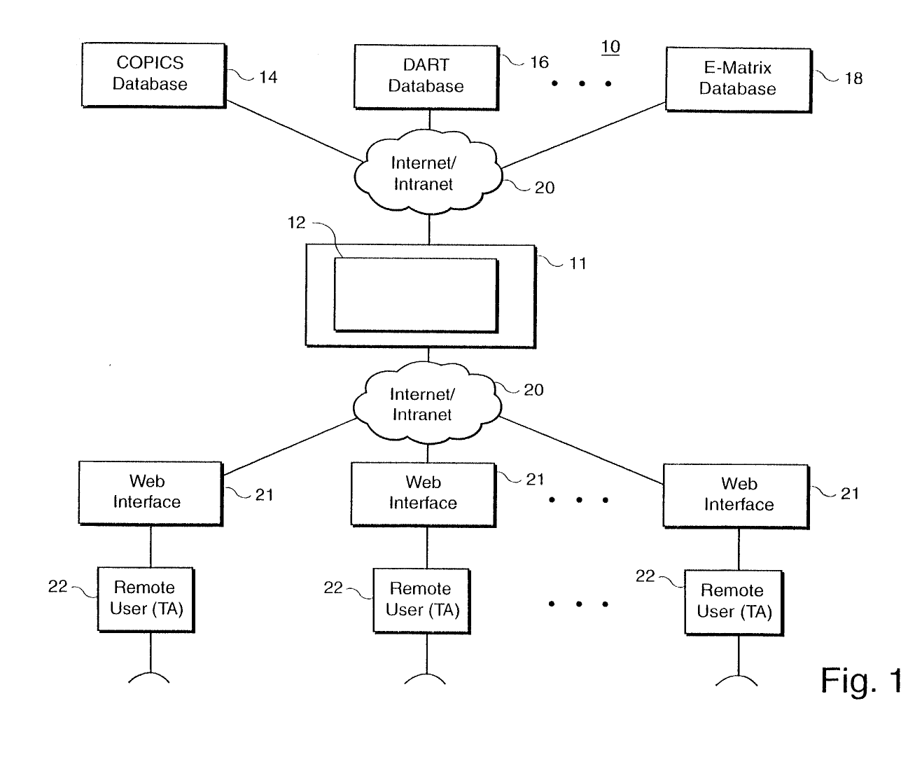

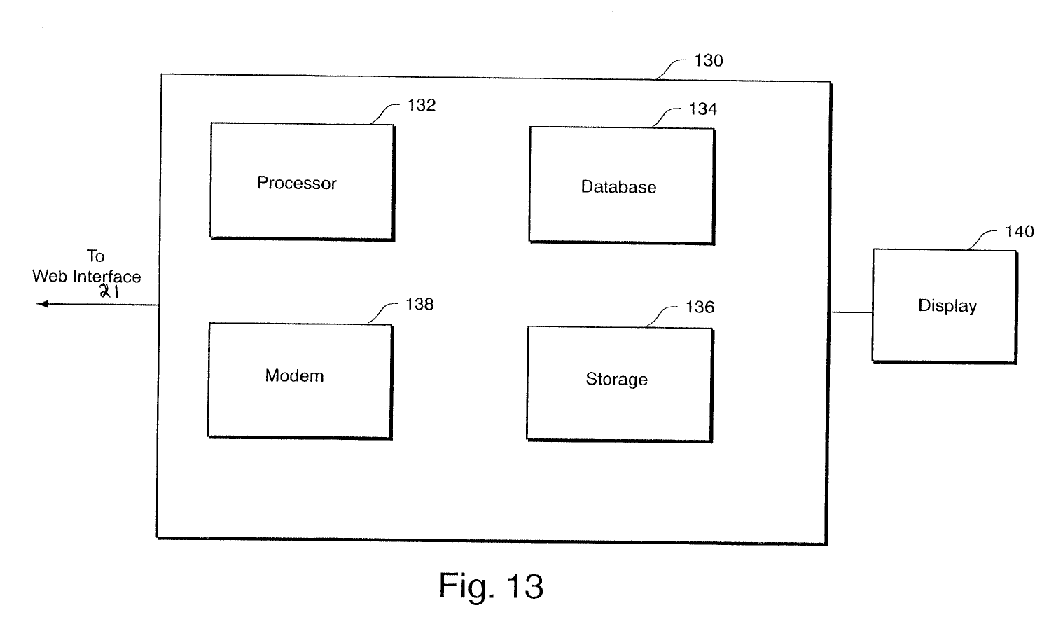

FIG. 1 shows a high-level schematic illustrating an e-installation system 10 in accordance with an exemplary embodiment of the present Invention. The e-installation application software tool (“e-installation tool”) 12 is preferably stored as an application software in a computer server system 11. The e-installation system 10 further includes a plurality of distributed database systems, such as, for example, COPICS database 14 for storing drawing related data, a DART database 16 for storing references to the drawing related data stored in COPICS 14, and an e-matrix database 18 for storing business objects and workflow to support the installation software tool. The computer server system 11 is communicatively coupled with each of the distributed databases 14, 16, 18, respectively, via internet/intranet network 20. A technical advisor (TA) or a field engineer (FE) 22 located at a remote installation site may access the e-installation software tool 12 via internet/intranet network 20 that may be accessed via a web interface 21. Each TA or FE is equipped with a computer system 130 (FIG. 13) for carrying out equipment installation tasks. The computer system 130 may be provided with web browser software for enabling a user to access the internet 20.

To achieve an installation milestone, a number of tasks pertaining to that milestone preferably need to be performed. The TA performing or directing the installation tasks should preferably be provided access to the documents supporting the installation tasks. Exemplary documents may include drawings, procedural documents, and documents identifying other relevant technical information. The e-installation tool is preferably designed to provide the TA access to all the necessary information to support all tasks within an installation milestone.

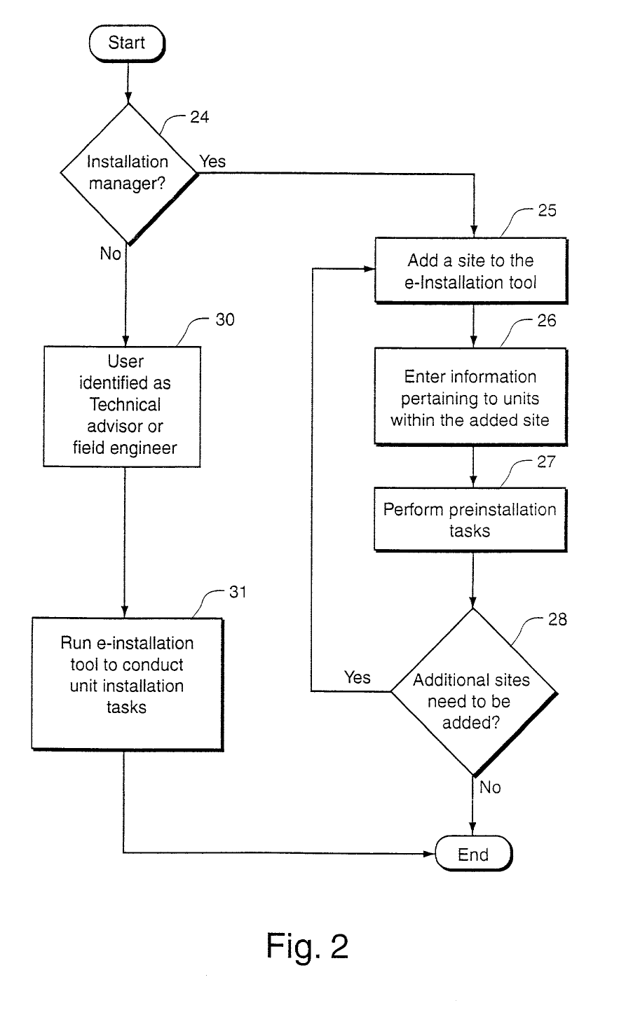

FIG. 2 is a flow chart illustrating the various functions undertaken by an installation manager. In step 24 it is generally determined whether or not the user is an installation manager or a technical advisor (TA) or a field engineer. If the user is an installation manager, then adding an installation site to the e-installation tool (FIG. 1) is considered to be a primary step undertaken by the installation manager or those personnel responsible for loading the installation tool with a unit/equipment and the supporting installation documents and a task sequence. This is generally indicated at step 25.

Once an installation site is established, information pertaining to various equipment/units under a given installation site are added by the installation manager, and other pre-installation tasks, such as, for example, closing a site, editing information within an established installation site, are performed as indicated at steps 26 and 27, respectively. A determination is made during step 28 to identify if there are further installation sites to be established by the installation manager. If there are no such tasks, then the tasks performed by the installation manager are complete. However, if there are additional installation sites that need to be established, such tasks are performed as indicated at step 29 in the form of a loop to step 25, and this process repeats itself until there are no more installation sites that need to be added by the installation manager.

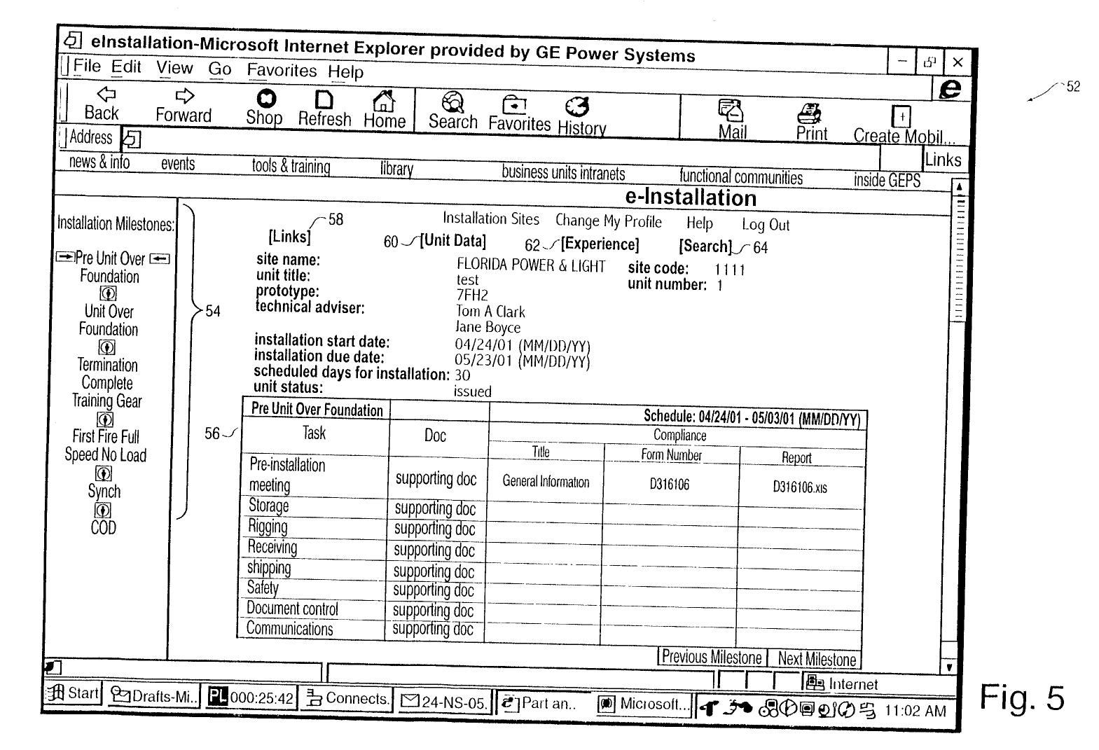

As indicated at step 24, if the user is determined not to be an installation manager, then the user is identified as a technical advisor (TA) or a field engineer at step 30. The TA then uses the e-installation tool (FIG. 1) by activating the e-installation tool in order to conduct the unit installation that has been setup by the installation manager during step 26. Once the e-installation tool is activated by the TA, a user-interface screen 52 as indicated in FIG. 5 is presented to the TA to proceed with unit installation tasks the details of which are presented with respect to FIG. 5 and therefore are not repeated here for simplicity.

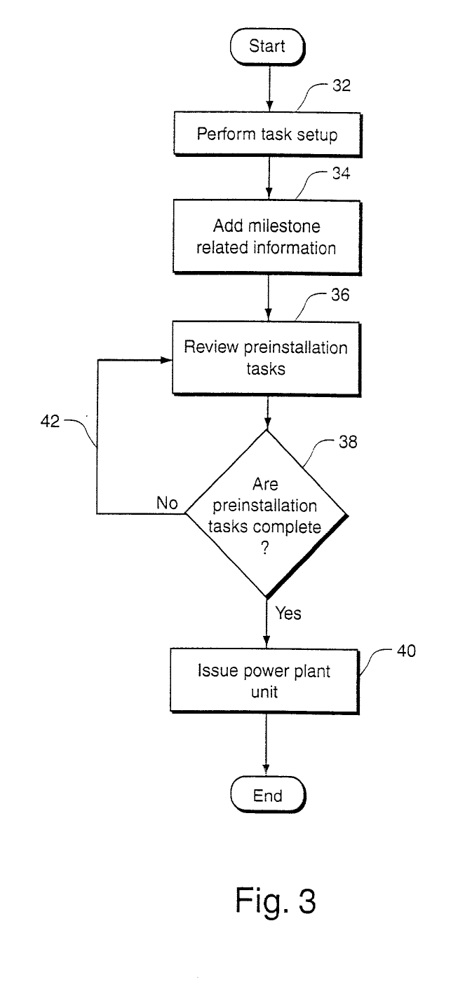

FIG. 3 shows a high-level flowchart illustrating the pre-installation process steps undertaken by an installation manager or other responsible personnel as noted earlier in reference to FIG. 2. The task setup step generally indicated at 32 is performed to populate the e-matrix database 18 (FIG. 1) with information pertaining to a unit/equipment being considered. Such information would include, for example, serial number of the unit, unit type, customer name, site name, project name, etc. The e-installation tool enables the installation manager to enter a machine type through a drop down menu. Subsequent entries may also be made corresponding installation date. Milestone related information along with scheduled times for defined tasks are entered as generally indicated at 34. During step 34, the installation manager may also modify the supporting documents pertaining to a task or a subtask in addition to adding other compliance forms to a task. Pre-installation tasks are reviewed during step 36, and if they are complete, the unit/equipment that is added is issued as indicated at step 40. Specifically, step 40 lists the installation task sequence and milestone schedule that have been set-up during steps 32 through 34, and allow the installation manager to issue the unit. Issuing the unit changes the status of the unit from “pending” to “issued”. The review process is iterated until the pre-installation tasks are completed.

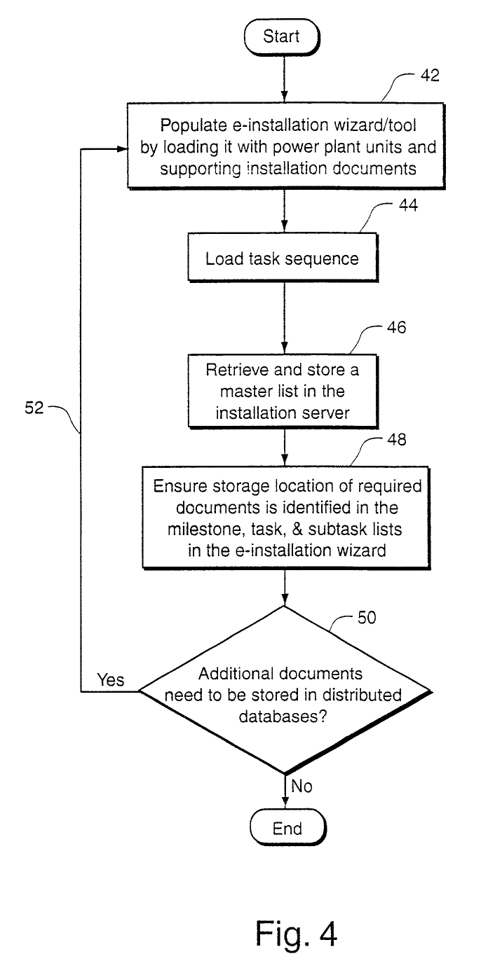

FIG. 4 shows a flowchart illustrating the process steps involved in populating the e-installation tool in accordance with an exemplary embodiment of the present invention. It is preferred that the e-installation tool include a complete reference to the required documents that are stored elsewhere in one or more distributed databases, such as, for example, COPICS 14, DART 16, e-MATRIX databases 18 as shown in FIG. 1. A masterlist includes information related to power plant equipment and references to installation documents that are stored in one or more of the distributed databases. The masterlist table also includes destination locations, in the e-installation tool, having links to the installation documents. The e-installation tool enables the user to perform installation tasks using the masterlist table by reading the created table and then automatically populating the e-installation tool with installation documents by retrieving the same from one or more distributed databases. Steps 42 through 48 generally depict the above process steps. In the event that additional documents need to be stored in one or more distributed databases, such information is stored and then the links in the e-installation tool are correspondingly updated. This step is generally indicated by the feedback loop at 52.

FIG. 5 shows a user screen interface of the e-installation tool in accordance with an exemplary embodiment of the present invention. Upon executing the e-installation tool, the TA is presented with a user-interface screen 52 listing a plurality of major milestones generally identified at 54 after navigating through a unit of interest. Corresponding to each milestone identified on the user interface screen, a list of tasks 56 with document links for all supporting documents is displayed. Additionally, a link to a blank form corresponding to each task may also be retrieved by the TA for use towards compliance purposes. Once the compliance form is filled by the TA, it may then be uploaded into an e-matrix database 18 (FIG. 1) to represent a unit record data.

In order to activate a milestone, a user selects a milestone by double clicking on the milestone hyperlink via a user interface, such as a keyboard or a mouse. This step displays tasks, for the selected milestone, along with hyperlinks to supporting documents to a task or a sub-task. The user-interface screen 52 is also provided with a “search” icon 64 in order to assist a TA in performing a search on any subject related to installation tasks. The TA may be provided access to a search engine loaded in the computer server system 11 that may be indexed to search a number of distributed databases. It will be understood that the TA is not necessarily restricted access to the search engine installed in the computer server system 11 (FIG. 1). In fact, the TA may be provided with access to any search engine located on any of the databases connected to the e-installation system 10 by way of network 20. A “links” icon 58 enables the TA to link to other existing installation tools and applicable home pages developed to support the installation process.

The “links” icon 58 may be used to serve as a seamless bridge to all other installation tools that may have been developed by other groups supporting respective installation tasks. For example, the e-installation tool 12 may be linked with a product service “red flag” review process which is preferably provided as one of the key links to the e-installation tool 12. Additional links establishing communication with the e-installation tool 12 include, for example, FMI section of a “Global Connector” and COPICS 14 and DART 16 databases (FIG. 1), for enabling a TA access information stored in these databases during installations.

The e-installation tool 12 (FIG. 1) is also provided with an “experience” icon in order to enable the TA to communicate with others the lessons learned and experience gained during a given installation task. This feature enables the TA to share data, method and findings with other TA's performing similar installation tasks.

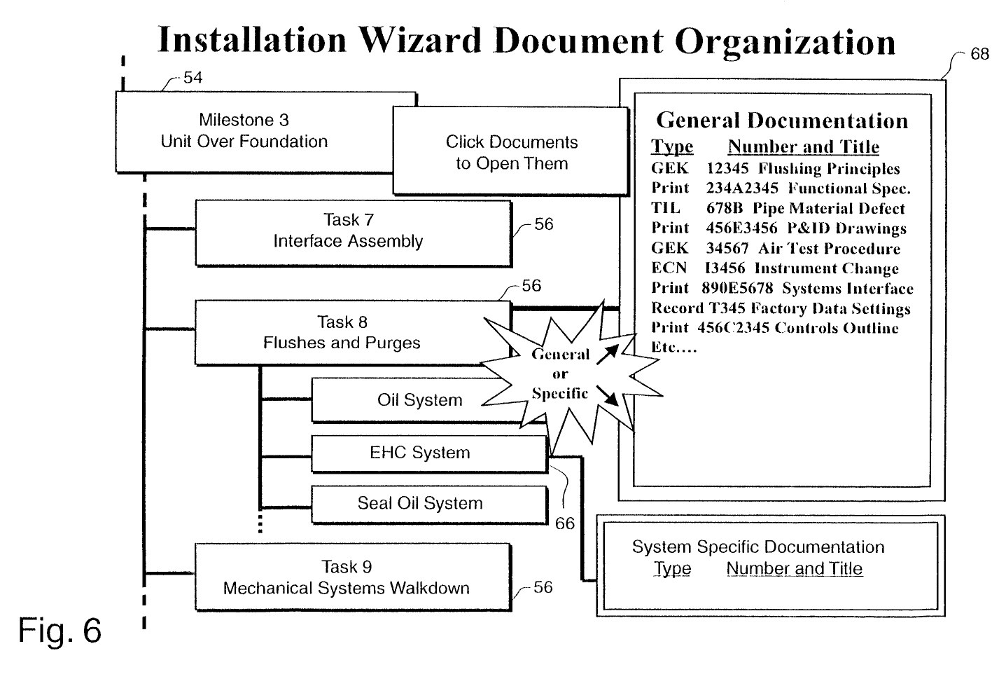

FIG. 6 illustrates an exemplary organization of the e-installation tool 12 (FIG. 1) of the present invention. In order for the e-installation tool 12 to perform its intended tasks, it is preferred that a complete reference to the required documents be provided in the e-installation tool. A reference to the documents may also be required in the correct milestone, task and sub-task categories of the e-installation tool. That is, all referenced drawing numbers included in the structure of the COPICS database 14 (FIG. 1) preferably should reside in the DART database 16 as it is considered a repository for drawings and supporting documents related to the installation of power plant equipment.

The above supporting documents are preferably organized in the e-installation tool in a fashion similar to a “Windows Explorer” set up. Folders are named according to the milestone, task and sub-task descriptions. A task may have documents linked to it that are general in nature, whereas a sub-task may have one more specific documentation linked to it based on the sub-task subject. For example, an installation milestone 54 may be hierarchically organized to include tasks 56 and subtasks 66. It will be appreciated that task and subtask details are also displayed with respect to FIG. 5 in the form of a user interface.

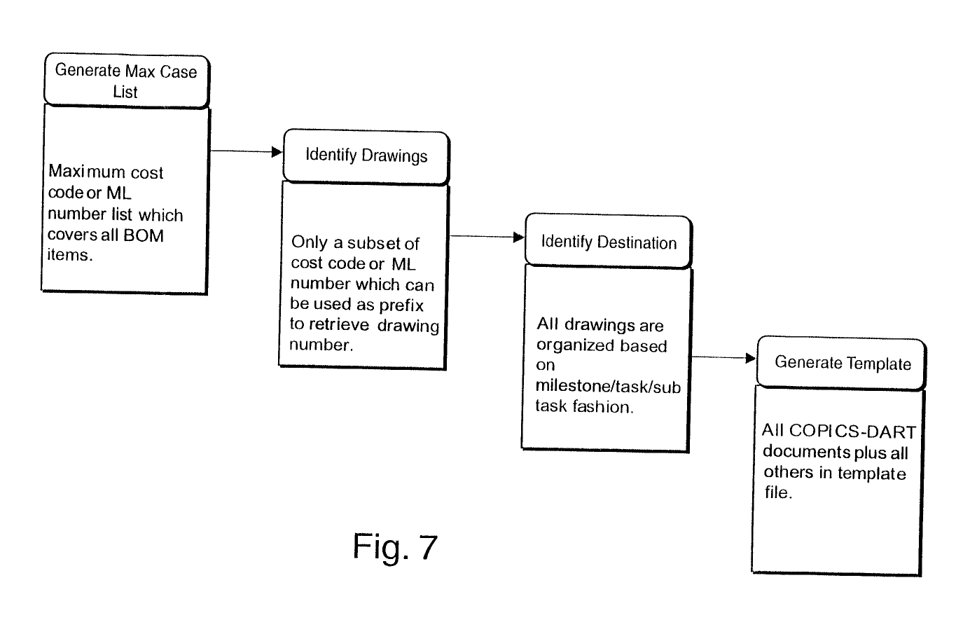

FIG. 7 shows a flowchart illustrating the process steps involved for generating a template/masterlist table from information provided by a technical advisor (TA) or a remote user. For example, a masterlist may be considered to be a superset with information about various equipment of several power-plants and references to various databases storing installation documents related to such equipment. The template that is generated from the masterlist may be considered to be a subset of the masterlist, and thus would preferably include information specific to an installation site or specific equipment at an installation site.

Thus, as shown in FIG. 7, from a maximum case list of cost code and/or model list item (MLI), installation information related to various power-plant equipment are identified. The destination of the installation information is also identified and organized based on an installation schedule milestone, task and sub-task.

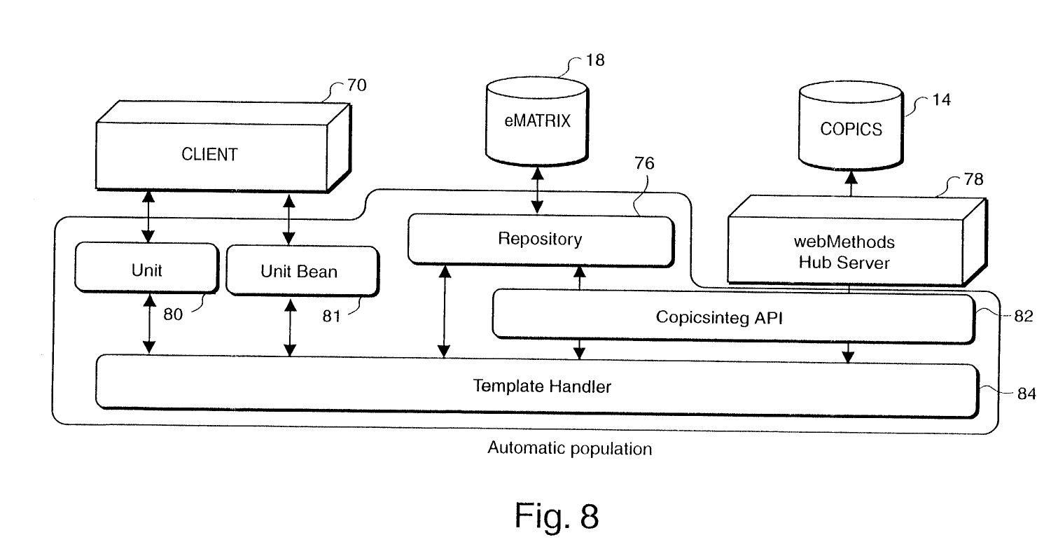

FIG. 8 is a schematic showing the architectural design of the e-installation tool for automatically populating the same during pre-installation. Information stored in databases, such as, for example, COPICS 14 and e-MATRIX 18 (FIG. 1) are retrieved and processed via repository 76, webMethods Hub Server 78 and application program interface 82. The processed information is forwarded to a template handler 84 to populate the e-installation software tool by generating business objects in the e-matrix database from the masterlist table as identified by the flowchart of FIG. 7.

JAVA Application Programmable Interfaces (APIs) Unit 80 and Unit Bean 81 process user requirements. Information about an equipment unit of a power-plant is encapsulated in Unit Bean 81, while actions pertaining to the equipment unit are executed through interface 80. For example, a unit number appears in Unit Bean as a unit number property and an action to populate a unit appears in a Unit as a method. Template handler 84 is an API that dispatches automatic population instructions to databases storing installation documents. The API of the Template Handler controls traffic flow in parallel with the Unit population. Hub Server 78 handles traffic from the COPICS database 14 (FIG. 1).

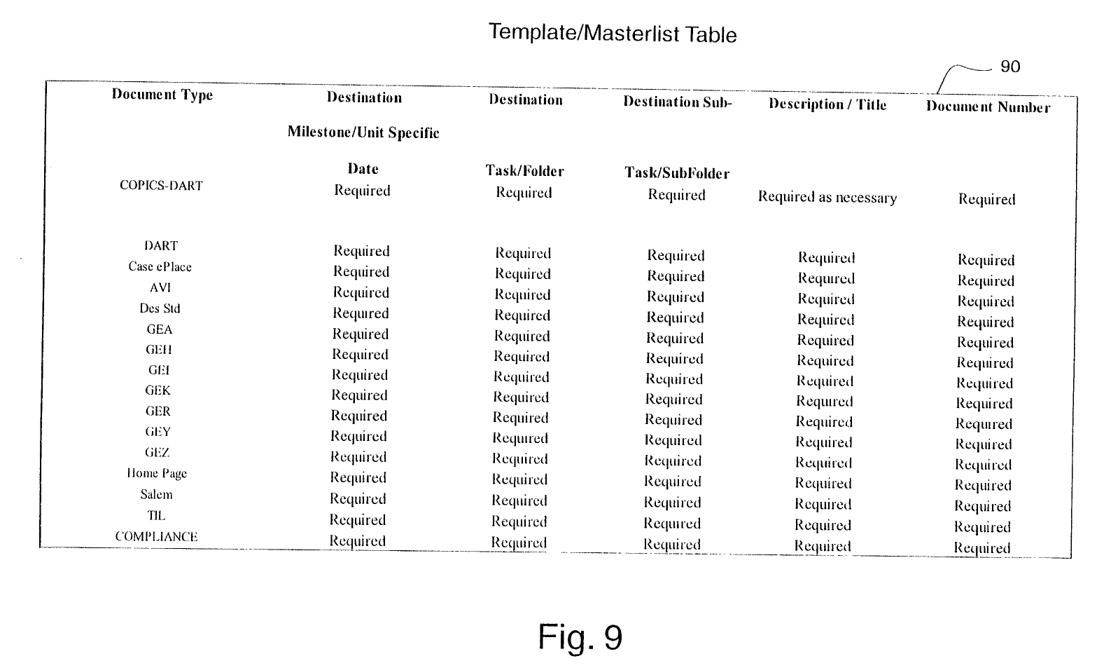

FIG. 9 shows an exemplary template/masterlist table 90 generated by following the flowchart identified in FIG. 7.

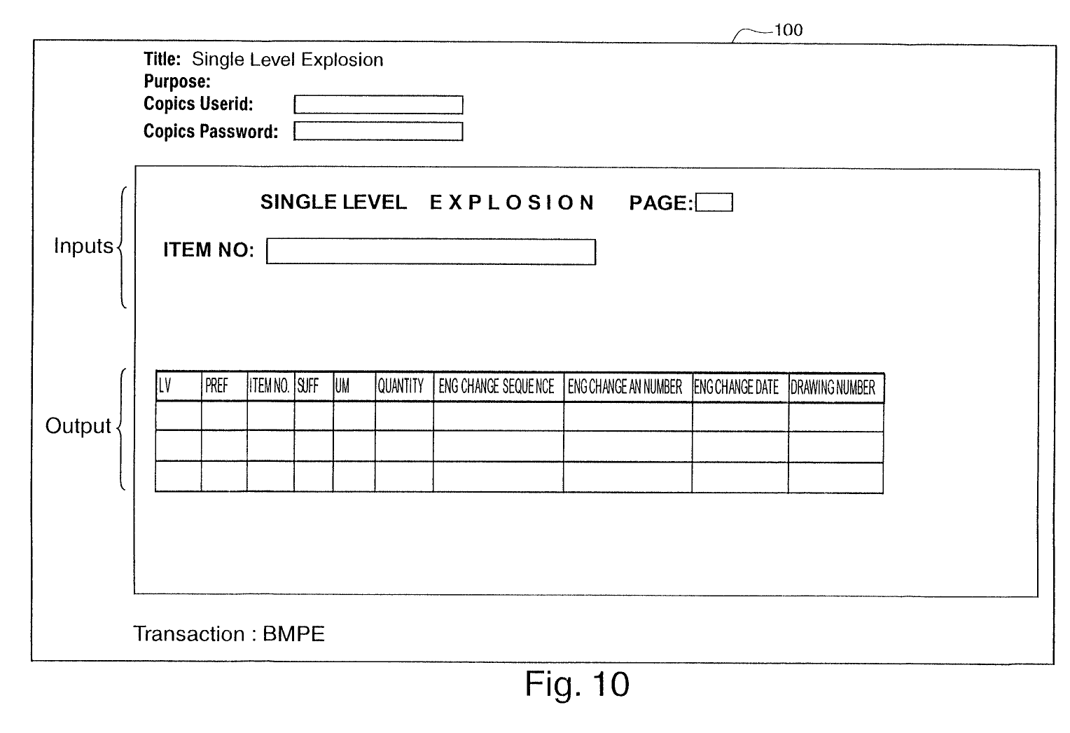

FIG. 10 shows an exemplary user interface 100 for viewing a single level structure of an existing bill of material. For example, once a user, such as a technical advisor (TA) or a remote field engineer enters a user-id and assigned password to access the COPICS database 14 (FIG. 1), the user may enter the item number and then retrieve an output corresponding to the entered item number. That is, once the COPICS BMPE receives a request for service with an item number, the COPICS BMPE transaction is executed using the item number as the input parameter. The results of the BMPE transaction are provided as a list of values that are returned as a reply from the service.

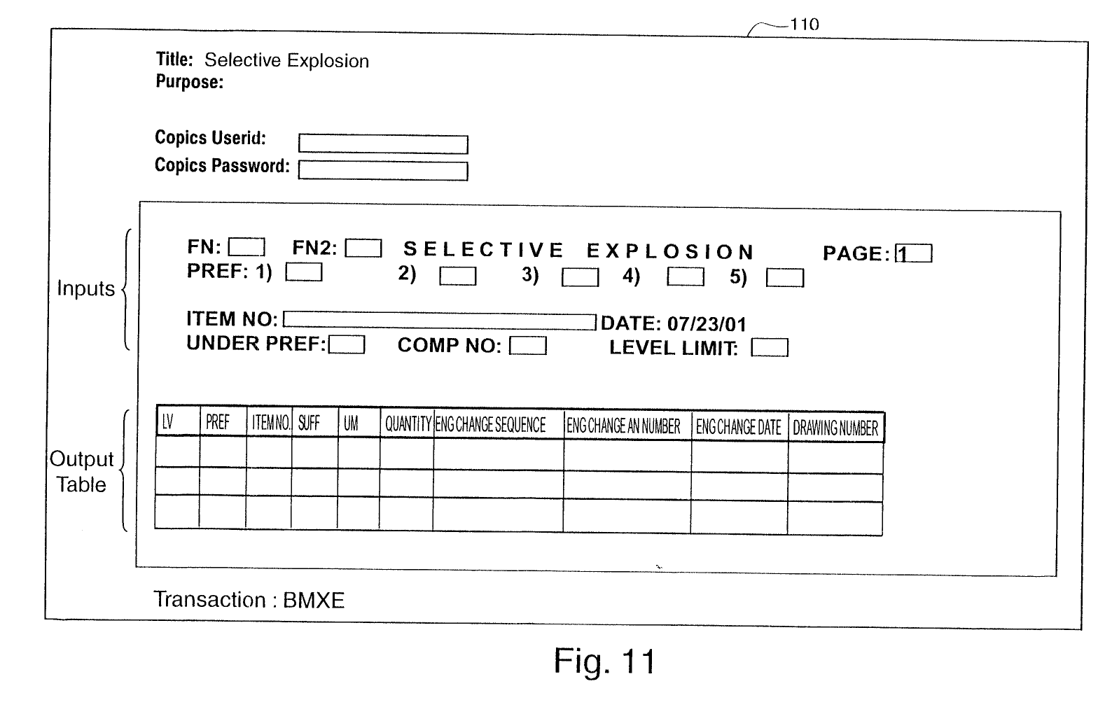

FIG. 11 shows a user interface screen 110 for enabling a user to determine a design number that is located on a particular bill of material stored in a particular area within a distributed database. The BMXE service of the e-installation tool/wizard searches for bill of materials in a selective explosion format.

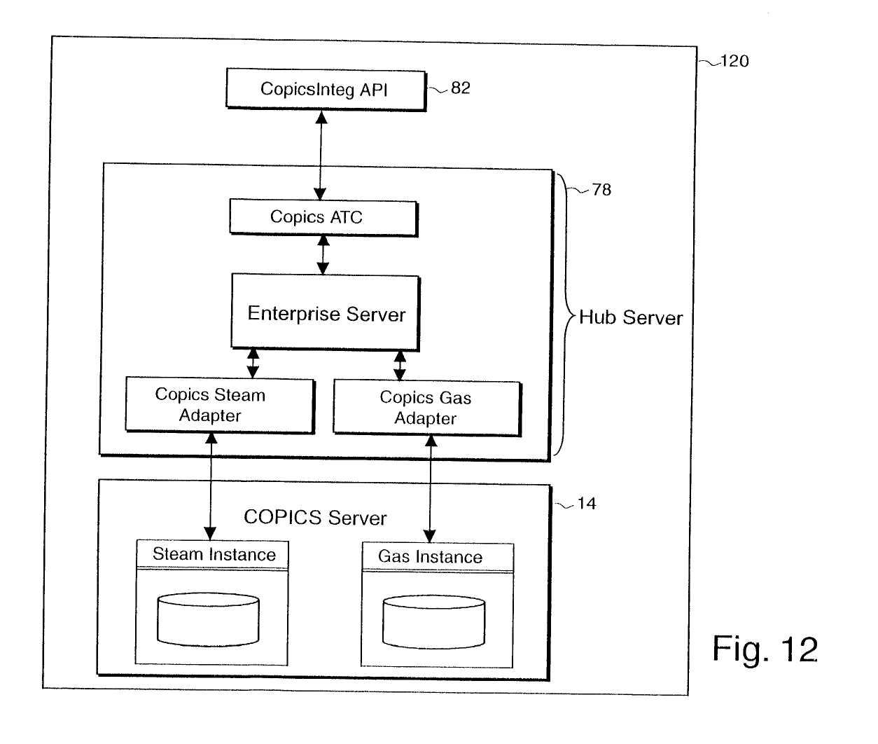

FIG. 12 shows an architectural diagram of COPICS EAI in accordance with an exemplary embodiment of the present invention. Specifically, architectural details of COPICS tool integration system 120 having JAVA API 82 for accessing a Hub Server 78. Hub Server 78 preferably includes a webMethods Enterprise Server, COPICS Application Transaction Coordinator (ATC), COPICS Steam Adapter and a COPICS Gas Adapter. The tool integration system 120 supports COPICS transactions such as for example, BMPE and BMXE identified in FIGS. 10 and 11.

FIG. 13 shows a computer system 130 carried by a technical advisor (TA) or a field engineer (FE) for enabling the FE or TA in the installation of power plant equipment. The computer system 130 includes a processor 132 for processing information received by the computer system, a database 134 for organizing the received information, a storage device 136. The computer system 130 further includes a modem 138 for enabling the FE to establish communication with the computer server system 11 (FIG. 1) not only to retrieve information from the computer server system 11 but also to communicate with other similarly situated technical advisors (TAs) or field engineers (FEs).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. In a communications network having at least one server, a plurality of distributed databases communicatively linked to the server, and said distributed databases having installation documents related to power plant equipment stored therein, a plurality of users communicatively linked to the server, a method for providing access to installation documents for assisting at least one user in installing power-plant equipment, the method comprising:
(a) providing at the server an installation software tool for use by the user;
(b) supplying a list correlating source locations of installation documents stored in said plurality of distributed databases with installation software tool destination locations;
(c) populating the installation software tool with links to the installation documents using information from the list; and
(d) retrieving installation documents from said plurality of distributed databases in response to user selection of links using the installation software tool.

2. The method as in claim 1, wherein the plurality of distributed databases comprises first and second databases and the method further includes:
storing a bill of materials in the first database; and
storing documents associated with the bill of materials in the second database, the documents stored in said second database referring to the bill of materials stored in the first database.

3. The method as in claim 2, further including storing electronic media files in said second database.

4. The method as in claim 1, wherein the step of populating the software tool comprises using destination locations identified in said list to organize links to installation documents into a hierarchical set within the software tool.

5. The method as in claim 1, wherein the populating step comprises providing links to at least one of (i) a html document, (ii) a drawing file, and (iii) a text document.

6. The method as in claim, further comprising:
(e) enabling the remote user to search said plurality of distributed databases for installation documents related to the power-plant equipment; and
(f) providing links to resources to support installation of the power-plant equipment.

7. The method as in claim 6, further comprising:
(h) enabling the user to communicate over the network with other users performing installation tasks.

8. A computer-based method For helping a user to install power plant equipment, the method comprising:
executing on a computer, a software tool that provides the user with access to installation documents stored in any of a plurality of databases residing on plural further computers, the software tool displaying an installation schedule with milestone indices;
allowing the user to select a milestone index; and
in response to selection of a milestone index, displaying hierarchical set of tasks and subtasks associated with the selected milestone index, said set of tasks and subtasks having corresponding links to associated installation documents stored in said plurality of databases.

9. The method as in claim 8, further comprising:
if required, providing a link to an equipment data record compliance form for at least one task;
enabling the user to retrieve and populate the compliance form; and
transmitting the populated compliance form to one of said plurality of distributed databases.

10. A system for providing access to documents for assisting at least one user in installing power-plant equipment, the system comprising:
a plurality of databases, any of said databases storing installation documents;
a server having an installation software tool for use by the user;
a communications network communicatively coupling said server and said plurality of databases for enabling the user to access and retrieve installation documents from the server; and wherein
the server including a table having a listing source locations of installation documents stored in said plurality of databases and correlating destination locations in said software tool.

11. The system as in claim 10, wherein the plurality of databases comprises first and second databases.

12. The system as in claim 11, wherein said first database stores a bill of materials and said second database stores documents associated with the bill of materials, the documents stored in the second database referring to the bill of materials stored in the first database.

13. The system as in claim 12, wherein said second database further includes electronic media files.

14. The system as in claim 10, wherein the software tool comprises:
references to installation documents, the references being organized into a hierarchical set of tasks and subtasks; and
wherein the references are further organized using destination locations listed in the table.

15. The system as in claim 10, wherein the software tool is populated with links to at least one of (i) a html document, (ii) drawing file, and (iii) a text document.

16. The system as in claim 15, wherein the software tool includes a search feature for enabling the user to search said plurality of databases for documents related to the installation of the power-plant equipment, and a links feature for providing links to resources to support installation of the power-plant equipment.

17. The system as in 16, wherein the software tool further includes a communication link for enabling the user to communicate over the network with other users performing installation tasks.

18. A system for providing access digitized documents for helping a user to install power-plant equipment, comprising:
a plurality of distributed databases for storing the digitized documents related to power plant equipment;
an e-matrix database for storing a first set of data;
a server having an application software tool stored therein, said server communicatively coupled to said plurality of databases and said e-matrix database via a communication network;
said software tool when executed automatically populates the server with links to the digitized documents stored in the distributed databases; and wherein
said server is supplied with a list correlating source locations of installation documents stored in said plurality of databases with Installation software tool destination locations.

19. The system as in claim 18, wherein:
links to the digitized documents are organized into a hierarchical set.

20. The system as in claim 19, wherein said hierarchical set includes milestones, tasks, sub-tasks related to installation of power-plant equipment.

21. In a computer system coupled to an electronic communications network, said computer system including a display and at least one user input device, an equipment installation wizard for assisting engineers in performing tasks relating to installation and/or maintenance of heavy machines such as power plant equipment, said equipment installation wizard including:
a task scheduler that displays a predetermined sequence of plural tasks;
a resource detailer that displays a list of resources associated with said selected task in response to said user input device indicating selection of said task; and
a digital resource retriever operatively coupled to said resource detailer and responsive to said task selection and said user input device, said digital resource retriever allowing a user to select resources from said displayed list and automatically retrieving a digital version of said selected resources via the network,
wherein the wizard includes an automatic populator that dynamically updates the list displayed by said resource detailer by importing resource descriptions and associated tasks from at least one file.

22. The system of claim 21, wherein said digital resource retriever retrieves said resources based on universal resource locators.

23. The system of claim 21, wherein the resources include technical drawings of said equipment.

24. The system of claim 21, wherein the resources including installation manuals.

25. The system of claim 21, wherein the resources include bills of materials.

26. The system of claim 21, wherein the resources include streaming electronic media.

27. The system of claim 21, further including a compliance verifier that reports successful completion of said task over the network.

28. The system of claim 27, further including a chat facility that allows users to communicate over the network.

29. The system of claim 21, wherein said wizard can be accessed over the network via a web browser.

30. The system of claim 21, wherein the automatic populator conditions importation of resources into the wizard on the confirmed existence of said resources.

31. The system of claim 21, wherein the automatic populator conditions importation of resources into the wizard on confirmation of task definition by said task scheduler.
